(19) United States
(12) Patent Application Publication
(10) Pub. No.: US 2015/0302354 A1
(43) Pub. Date: Oct. 22, 2015

(54) COMPUTER SYSTEM AND COMPUTER-IMPLEMENTED METHOD FOR COLLABORATIVE DEVELOPMENT OF COMMON BUSINESS MODELS

(71) Applicant: VISEO, PARIS (FR)

(72) Inventors: Frank PRIORE, BILIEU (FR); Romuald COEFFIER, GRENOBLE (FR); Eric PERRIER, GARCHES (FR)

(73) Assignee: VISEO, PARIS (FR)

(21) Appl. No.: 14/255,888

(22) Filed: Apr. 17, 2014

(51) Int. Cl. G06Q 10/10

(52) U.S. Cl. CPC G06Q 10/103

(57) ABSTRACT

A computer system for collaborative development of common business models is described. The system has user terminals and a server. The server includes a module for defining a plurality of business universes, a space defining unit for defining a plurality of spaces, at least one viewer including a human-machine interface for accessing the spaces by entitled users, a unit for computing a distance value between nodal objects contents and models contents, and a convergence unit. The system allows nodal objects generated by different users to converge towards common models. A method is also described.

### FIELD

The present disclosure relates to systems and methods that provide a support for collaboration in a data processing system and more particularly to Business Process Modeling. In particular, embodiments of the present disclosure are directed to the field of software development methods, in particular representations of knowledge relating to a particular field of application such as Model-driven engineering systems>> or <<Business Process Modeling>>.

### BACKGROUND

Commercial software such as Mia® or Enterprise Architect® are software tools for Business Process Modeling enabling to generate, modify and use business Models. The open source programmers have tools such as Enterprise Architect® of Sparx® or Suite Rational® from IBM® that manipulate data processing objects and that are intended for IT professionals. Software such as Asana® or Jostle® allow the use of pre-existing Models. Microsoft Excel® or Google Docs® allow to define steps and data of the business processes, but do not allow to Model them.

Nevertheless, according to the article “A research roadmap towards achieving scalability in Model driven engineering”, Kolovos, Rose and Matragkas, Proceedings of the Workshop on Scalability in Model Driven Engineering. ACM, 2013. p. 2), as Model-Driven Engineering (MDE) is increasingly applied to larger and more complex systems, the current generation of Modeling and Model management technologies are being pushed to their limits in terms of capacity and efficiency. Additional research and development is imperative in order to enable teams of Modelers to construct and refine large Models in a collaborative manner.

Practically, all the proposed solutions face the technical issue to efficiently develop a business Model collaboratively.

### SUMMARY

The inventors have observed that three goals are necessary for the information system to allow to fully benefiting from Business Process Modeling:
allow behavioral Models to emerge from unstructured or semi-structured data from the field (bottom-up approach), in contrast to the classical approach consisting in defining Models and then to uniformly apply them to the field (top-down approach),
enable and coordinate intrinsically collaborative construction processes and activities,
make processes and models in progress efficiently converge while they are designed, in compliance with a common objective.

From there, the inventors have designed a method allowing corporate specialists to collaboratively define a Business Model consisting in data structures, actions and workflows thanks to multi-directional exchange of business information, from semi-structured information consisting in data and/or existing Models. The Modeling of a common Business Model, defined approximately in a first step, can thus be gradually refined by iterations from multiple users on a collaborative cognitive map for reaching a representation which can be understood by each of these users.

More specifically, embodiments of the present disclosure seek to propose a computer system and a computer-implemented method allowing to a set of users to cooperatively develop a common Business Model more quickly, efficiently and reliably.

To this end, the present disclosure provides according to a first aspect a computer system for collaborative development of common business models, said system comprising: a set of user terminals, a server accessible by said user terminals, said server comprising: a module for defining a plurality of Business Universes, each Business Universe being associated to a corporation activity and including a plurality of Models, each Model comprising a data structure corresponding to a type of corporate activity, and for storing data representative of said Business Universes, a Space defining unit for defining a plurality of Spaces, each Space being associated to one among a plurality of business universe identifiers to at least one identifier of an authorized user, and a plurality of nodal objects, and for storing data representative of said Spaces, each nodal object being an object of a graph and comprising data items generated by users inputs, at least one Viewer including a human-machine interface for accessing the Spaces by entitled users, for creating or editing Models, for creating and editing Nodal Objects in the respective Spaces, a Distance determination unit for computing a distance value between contents of said Nodal Objects and contents of said Models, a Nodal Object/Model convergence unit for iteratively for assigning a Models to Nodal Objects generated by different users, and for making nodal objects contents mutually consistent, in response to the Distance determination unit,

whereby different Nodal Objects generated by different users can be caused to converge towards common models.

Preferred but non limiting additional features of this system are the following, taken individually or in any technically compatible combinations:
the system further comprises a Recognition unit for recognizing Nodal Object structures edited in a Viewer, and said Nodal Object/Model convergence unit is capable of assigning Models to Nodal objects also in response to the Recognition unit.
said Recognition unit is capable of recognizing data structures based on data links and data formats.
said Distance determination unit comprises means for detecting format identities and content similarities.
said Viewer comprises means for generating a Nodal Object from an “empty Nodal Object” Model among said Models.
the system further comprises a Viewer management unit for managing a plurality of Viewers, each Viewer being built from one or several Editors of different types.
said Recognition unit comprises means for detecting tree-structures in data inputted by users and for generating corresponding data structures in Nodal Objects.
said Viewer comprises means for generating a new Model from the data structure of a generated Nodal Object.
said Nodal Object/Model convergence unit comprises means for displaying a plurality of Model names sorted out in response to Distance determination by said Distance determination unit.
said a Nodal Object/Model convergence unit comprises means for copying data items from Models to Nodal Objects to which such Models have been assigned.

According to a second aspect, the present disclosure provides a computer-implemented method for collaborative development of common business models by a plurality of users, said method comprising the following steps: providing a set of user terminals and a server accessible by said user terminals, the server comprising a Business Universe module, a Space unit, a Distance unit and a Convergence unit; defining, by the Business Universe module, a plurality of Business Universes, each Business Universe being associated to a corporation activity and including a plurality of Models, each Model comprising a data structure corresponding to a type of corporate activity, and storing data representative of said Business Universes; defining, by the Space unit, a plurality of Spaces, each Space being associated to one among a plurality of business universe identifiers to at least one identifier of an authorized user, and a plurality of nodal objects, and storing data representative of said Spaces, each nodal object being an object of a graph and comprising data items generated by users inputs; in response to inputs by a plurality of authorized users through the user terminals in a given Space, generating in and editing in dedicated Viewer Models and Nodal Objects, as said Models and Nodal Objects are generated and edited: performing, by the Distance unit, Distance determination between inputted data, iteratively for assigning Models to Nodal Objects generated by different users, and making Nodal Objects contents mutually consistent, in response to the Recognition and Distance determination steps, whereby different Nodal Objects generated by different users can be caused to converge by the Convergence unit towards common models.

Preferred but non limiting additional features of this method are the following, taken individually or in any technically compatible combinations:
the method further comprises, as said Models and Nodal Objects are generated and edited:

performing data structure Recognition on said Nodal Objects,
said Recognition step is capable of data structure recognition based on data links and data formats.
said Distance determination step is capable of detecting format identities and content similarities.
said generating and editing step comprises generating a Nodal Object from an “empty Nodal Object” Model among said Models.
the method comprises an initial step of selecting one particular Viewer among a plurality of Viewers, each Viewer being built from one or several Editors of different types.
said Recognition step is capable of detecting tree-structures in data inputted by users and for generating corresponding data structures in Nodal Objects.
said generating and editing step comprises generating a new Model from the data structure of a generated Nodal Object.
said assignment step involves displaying a plurality of Model names sorted out in response to the Distance determination step.
the method comprises a step of copying data items from Models to Nodal Objects in response to assignments.

### BRIEF DESCRIPTION OF THE DRAWINGS

Other features, aims and advantages of this disclosure shall appear more clearly from the following detailed description of preferred embodiments thereof, given by way of a non-limiting example and made with reference to the appended drawings, in which:

FIG. 1 illustrates a data-processing system adapted for implementing the present disclosure,

FIG. 2 illustrates a main process implementing the disclosure,

FIG. 3 illustrates the display in a Viewer of the technical elements of the disclosure, namely Spaces, Business Universes, Nodal Objects and Models,

FIG. 4 illustrates the display in a Viewer of the generation of a Nodal Object and of a Model,

FIG. 5 diagrammatically shows the display in a Viewer of the application of a Model to a Nodal Object,

FIG. 6 shows in greater detail a part of the main method for computing the Distance between a Model and a Nodal Object,

FIG. 7 shows in greater detail a part of the main method for applying a Model to a Nodal Object.

### DETAILED DESCRIPTION

### 1) Definitions and Preliminary Remarks

This disclosure involves the concepts of Space, Business Universe and Nodal Objects, which will be defined in the following.

The other expressions used in the present description are by default those of the ISO standard “Unified Modeling System” defined by the Object Management Group, which standard is being herein incorporated by reference in its entirety, and in particular:

Behavior: observable effects of an operation or of an event, including the results thereof,

Composit: a class connected to one or several classes by a Composition relationship,

Composition: a specific type of relationship describing how one object is composed of another object,

Domain: a logical grouping that explicitly declares a rule that defines ownership of objects based upon some type or Property,

Instance: an instance is a concrete manifestation of an abstraction to which a set of operations can be applied and which has a state that stores the effect of the operation,

Model: semantically closed abstraction of a system,

Module: storage and processing software unit,

Object: a runtime instance of a Class,

Object Diagram: a diagram that includes the objects and their links at a given point in time,

Property: an Attribute or an Association,

Type: the options are: an elementary Value type such as integer, string, date, or Boolean or a reference type defined in a Class.

It will be noted that the above expressions will also encompass in the following description all associated information in its form stored in a computer memory and in certain cases the underlying device. For instance, a “user” in the meaning of the present description shall also cover, depending on the context, the corresponding user identifier stored in an appropriate location in the system memory, or a client device such as a computer terminal.

### 2) Preferred Embodiment of the System

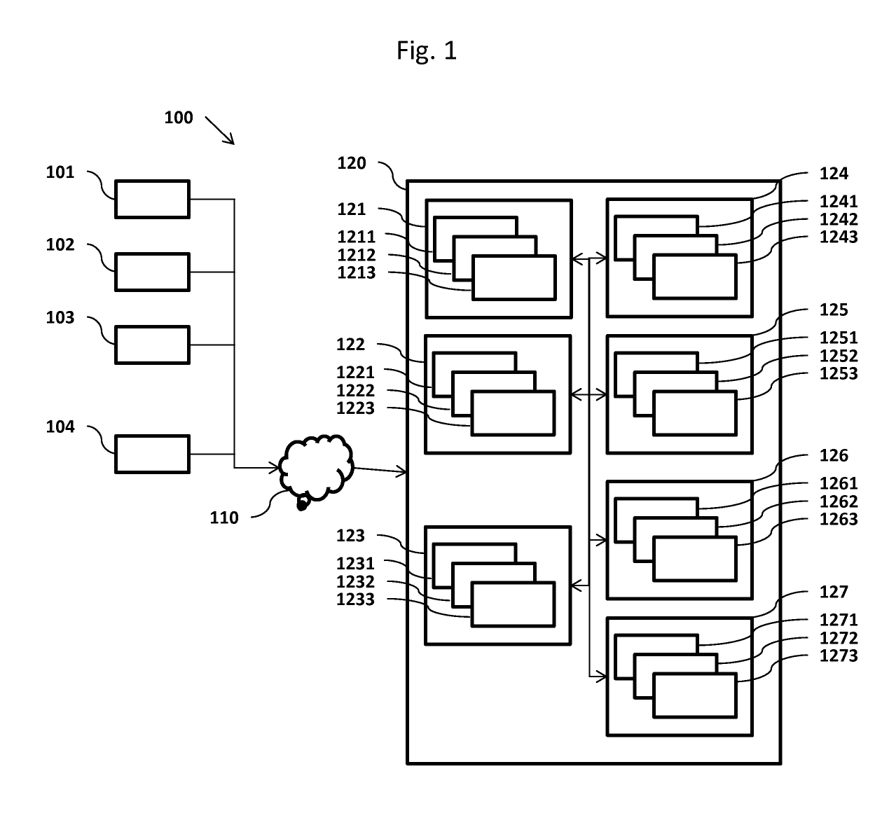

Referring to FIG. 1, the disclosure provides a data processing system 100 in which a plurality of users 101, 102, 103 and an administrator 104, provided with client devices such as computer terminals, connect via a communications network 110 such as the Internet to a computer server 120. This server 120 contains a plurality of management Modules 121, 122, 123, 124, 125, 126, 127 with interfaces allowing them to cooperate with each other. These will now be described in detail.

### a) Space Management Module

The Space management Module 121 comprises a processor programmed for generating modifying, using and deleting data stored in the server memory and representative of Spaces 1211, 1212, 1213.

A Space 1211 is the assembly of a Business Universe 1231, of a group of identifiers associated to users such as 101, 102,103 and of Nodal Objects 1241, 12421, 1243 (as will be described below). A Space is “private” when it is accessible by only one user. The Space data are stored in the server memory.

When registering a new user 101 in the Rights management Module 126 as described below, this Module 126 generates and stores in the server memory a private Space 1211 and the access right 1261 for this new user 101 to this private Space 1211.

This Module 121 also comprises a human-machine interface enabling the administrator 104 or the users 101, 102, 103, depending on their rights 1261, 1262, 1263, to generate other Spaces 1211, 1212, 1213. This human-machine interface comprises a display and input devices such as a keyboard, a mouse, etc.

### b) Viewer Management Module

The Viewer management Module 122 comprises a processor programmed for adding, parameterizing, using and deleting data representative of Viewers 1221, 1222, 1223, stored in the server memory.

A Viewer 1221 comprises business-oriented Editors such as a Record Editor 12212, a text Editor 12213, a mind mapping Editor 12214, a Gantt chart Editor, a ToDo list Editor, a meeting organizer, etc., these Editors comprising program instructions stored and accessible by a processor in said server.

The Viewer management Module 122 comprises a human-machine interface allowing a user 101, 102, 103 to access to data representative of a Space 1211 and to interact therewith through a Viewer 1221.

This interaction allows for example a user 101, in relation to his access rights 1261:
to generate, visualize or modify data representative of a Nodal Object 1241 of the Space 1211, stored in the server memory,
to generate, visualize or modify data representative of a Model 1251, stored in the server memory,
to validate a proposal generated by the server processor for applying a stored Model 1251 to a stored Nodal Object 1241,
to visualize a subgraph.

### c) Business Universe Management Module

The Business Universe management Module for 123 comprises a processor for generating, modifying, using and deleting data stored in the server memory and representative of Business Universes 1231, 1232, 1233.

A Business Universe 1231 is the instance of a Domain, stored in the server memory. It groups together a set of data representative of Models 1251, 1252, 1253 relating to a business or corporate activity type (commercial, sales administration, human resources, finance, etc.).

### d) Nodal Object Management Module

The Nodal Object management Module 124 has a processor for generating, modifying, using and deleting data representative of Nodal Objects 1241, 1242, 1243.

A Nodal Object 1241, 1242, 1243 is an Object which is a node of a graph stored in the server memory and which can become a Composit at any time.

A Nodal Object 1241 is said to have a “type” when it complies with a Model 1251. In this case, the Nodal Object is a stored instance of this Model 1251 and is associated to a “Type Model” 12414, the title of which is that of this Model 1251. The “Structure” of a Nodal Object contains the titles of the Properties, the associated formats, their tree-structure, all stored in the server memory, but not their values.

A Nodal Object can be opened with one or several predefined Viewers 1221, 1222, depending on the desired context.

The Nodal Object management Module 124 comprises a processor for applying a Model to a Nodal Object, according to the method 214 described in detail below.

### e) Model Management Module

The Model management Module 125 comprises a processor for generating, modifying, using and deleting data representative of Models 1251, 1252, 1253.

A Model 1251 is a stored Nodal Object Structure 1241, 1242-1243 or a set of stored Nodal Object Structures 1241, 1242, 1243 declared as a Model, associated to the stored data of a Business Universe 1231 and characterized by stored data representative of Behaviors.

A Model 1251 facilitates the generation of new Nodal Objects 1241 by data duplication according to a method described below.

### f) Rights Management Module

The Rights management Module 126 comprises a processor for generating, modifying, using and suppressing data representative of rights 1261, 1262, 1263 respectively associated to stored user identification data corresponding to to users 101, 102, 103, 104.

When registering a new user 101, the access right 1261 for this new user to his private Space 1211 is generated and stored by the rights management Module 126.

The administrator can modify the stored data representative of these access rights 1261, 1262, 1263.

The rights 1261 of a user 101 define in particular, for each Space:
his accesses and authorizations for generating, modifying, visualizing or deleting content stored in the server memory,
the sharing of all or part of this content with another user such as 102 or 103.

### g) Algorithm Management Module

The Algorithm management Module 127 comprises a processor for adding, modifying, using and deleting stored program instructions representative of algorithms, such as the Recognition algorithm 1271 and that the Distance algorithm 1272.

A Recognition 1271 is a processor-executed Algorithm for identifying a data structure or data items such as:
In a stored text, keywords pre-recorded in a lexicon, predefined formats (date, address, text, list, number, etc.), or a structure (numbered subparagraphs, tabulation, line feed, star character, etc.),
In a stored graph of text boxes linked to each other, processes such as a logic controller, a social graph,
In mixed representations: stored structures such as an ordered association of the above items (contact forms, process, argument, list . . . ).

The Distance 1272 is a value which is computed and stored and which reflects the similarity rate between a Recognition 1271 applied to a Nodal Object 1241 on the one hand, and a Model 1254 on the other hand.

This computation involves keywords, of formats, of parts of tasks sequence, of processes, of social graphs or of structures common there between, all stored in the server memory.

For the sake of simplicity, the expression “Distance” designates both the instruction set representative of the Algorithm and the stored result of the computation made thereby, i.e. the similarity rate.

The Recognition 1271 and Distance 1271 are computed and stored after each input by user 102. As a result, the content of box 12218, updated fur each input, may comprise a stored list of at most N Models (N being for instance equal to 5), depending on the size of the Business Universe 1231 and of the Distance between these Models and the Nodal Object being generated or modified, this Distance being computed in step 212 according to a method described below.

### 3) Preferred Embodiment of the Method

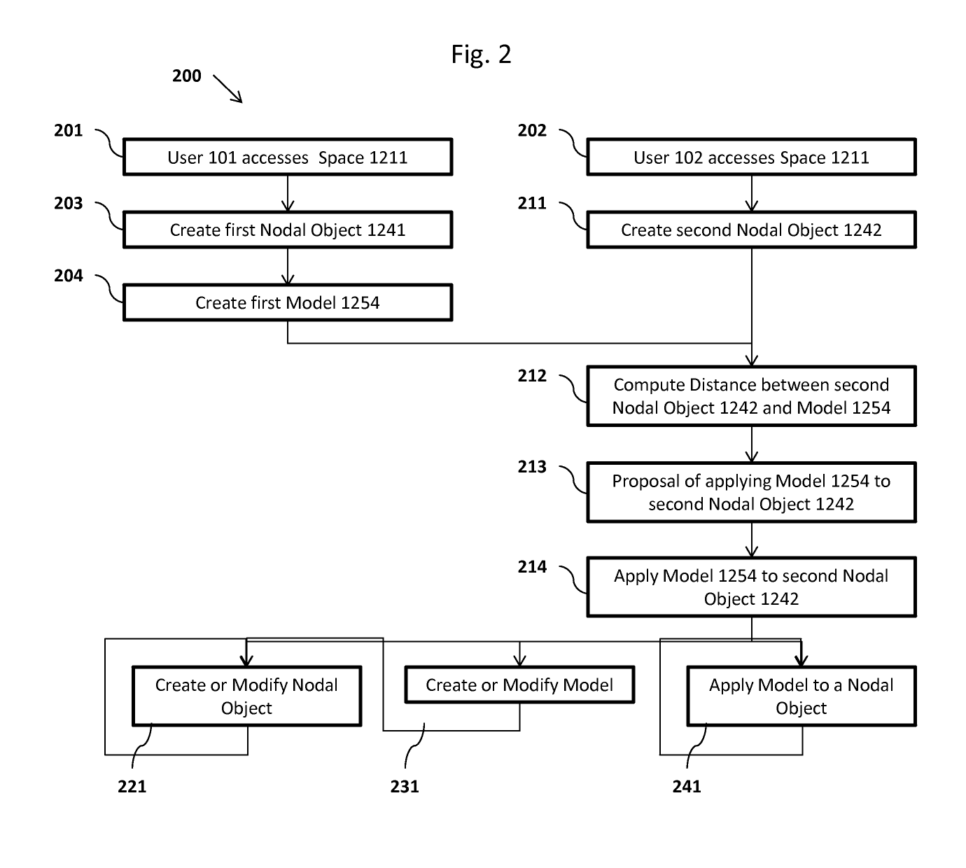

Referring to FIG. 2, the main method 200 of the disclosure is defined by the following actions and steps:

### a) Space Access

In step 201, a first user 101 accesses via his terminal to data representative of a Space 1211 associated to a Business Universe 1231, stored in the server memory, and interacts therewith thanks to a first Viewer 1221 displayed on his terminal.

In step 202, a second user 102 accesses data representative of the same Space 1211 and interacts therewith thanks to this first Viewer 1221 or to a second Viewer 1222 displayed on his terminal.

The access authorization 1262 to this Space 1211 for this user 102 is obtained either by executing and invitation process caused by terminal or user 101, or by a terminal of an administrator 104.

### b) Nodal Object, Model

In step 203, the terminal of first user 101 causes, at the server level, the generation of data representative of a first Nodal Object 1241 thanks to the Viewer 1221 in cooperation with the Space management Module 121 and the Nodal Object management Module 124.

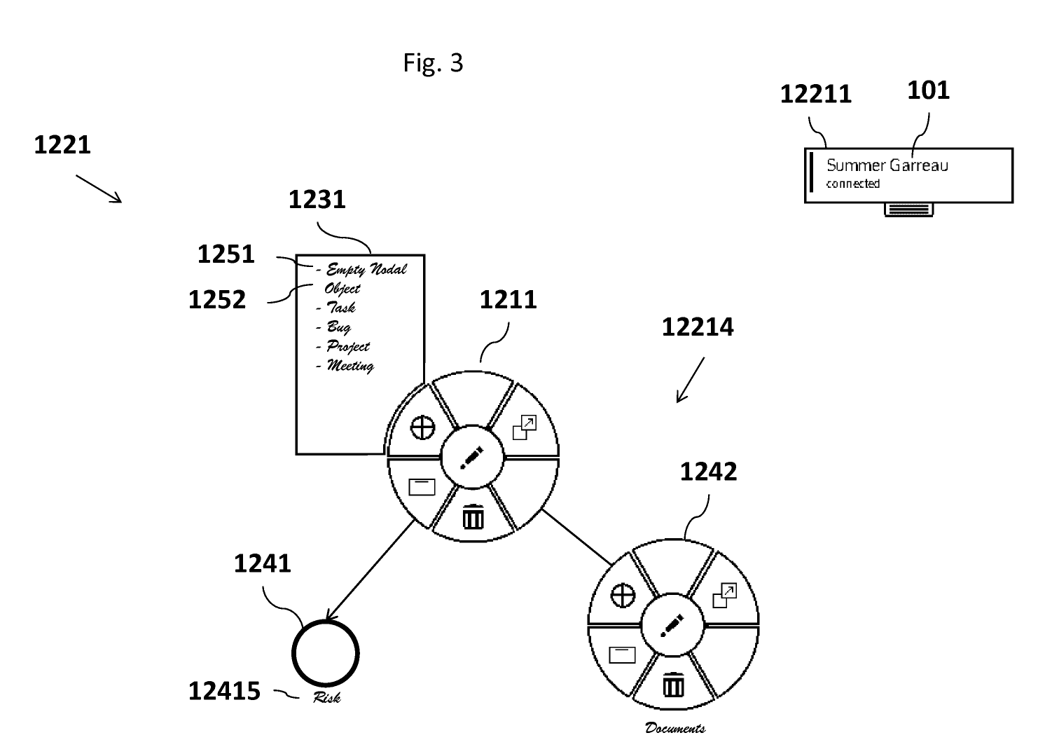

Referring to FIG. 3, the terminal of user 101 causes the generation of data representative of a Nodal Object 1241 by instantiating the stored Model 1251 entitled <<Empty Nodal Object>>, this being caused by the used clicking on its wording or label in the Business Universe 1231.

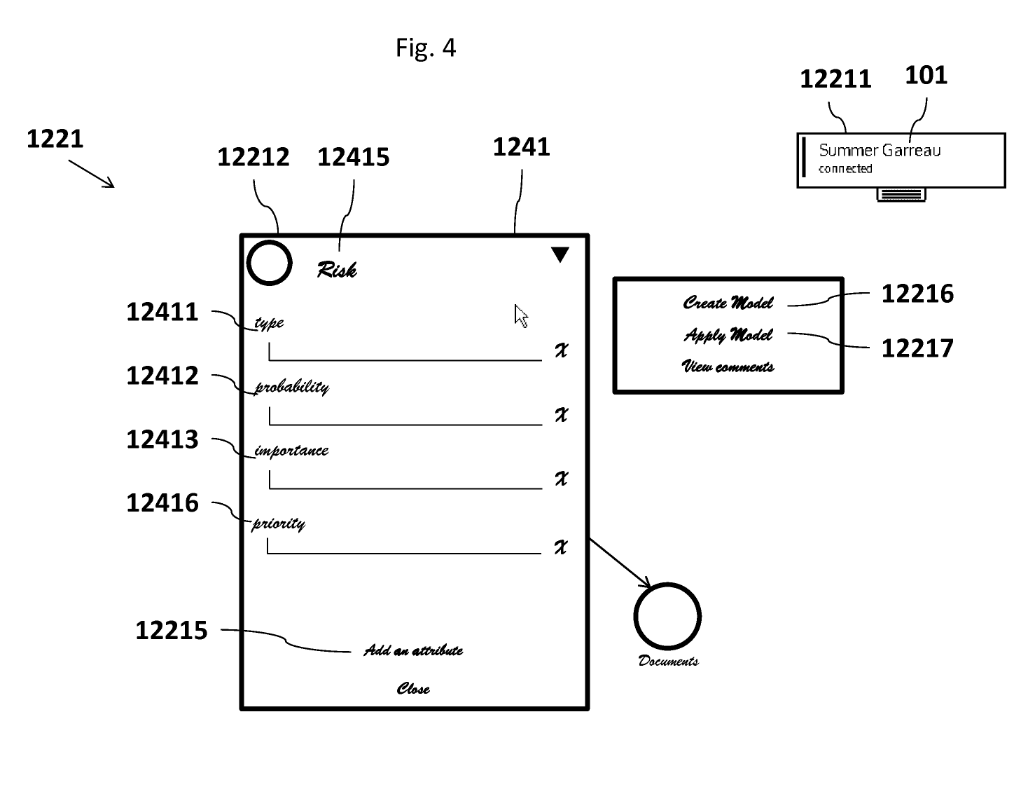

Referring to FIG. 4, user 101 modifies the data representative of Nodal Object 1241 thanks to the Record Editor 12212 by:
clicking on the Property generation button 12215,
inputting semi-structured text,
as the inputting progresses, causing the Algorithm management Module 127 to apply a Recognition 1271 to this semi-structure by means of a cooperation of Modules 122 and 127,
causing the Nodal Object management Module 124 to update the data representative of Nodal Object 1241 that results from the application of Recognition 1271.

In step 204, this first user 101 causes the declaration of this first Nodal Object 1241 as a Model 1254 thanks to the Record Editor 12212 by activating the Model generation button 12216 of the menu. The Model management Module 125 cooperates with the Nodal Object management Module 124 and the Business Universe management Module 123 for generating and storing a new Model 1254.

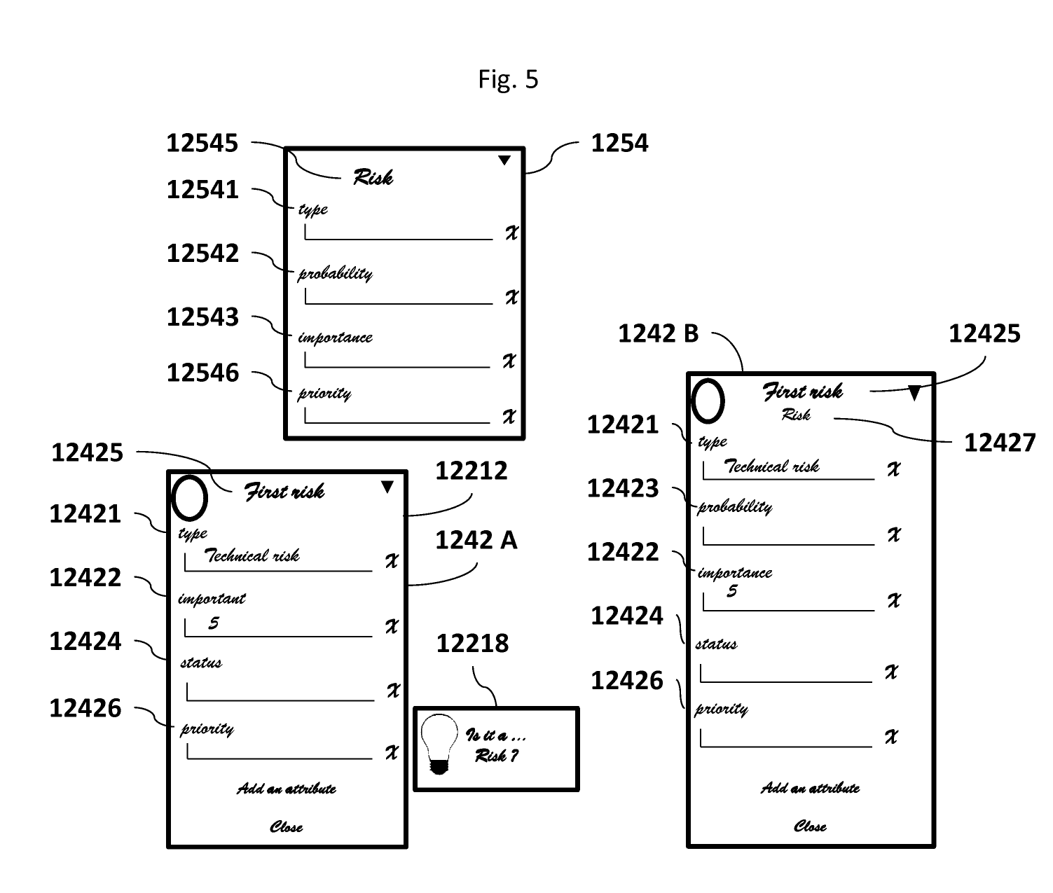

Referring to FIGS. 4 and 5, the Properties 12541, 12542, 12543, 12544 of this new Model 1254 are respective stored copies of the wordings and formats of the Properties 12411, 12412, 12413, 12416 of Nodal Object 1241. The title 12545 of this new Model 1254 is also a copy of the title 12415 of this Nodal Object 1241. Moreover, the data representative of this new Model 1254 is added to the data representative of the active Business Universe 1231.

### c) Application of a Model to a Nodal Object

In step 211, the second user 102 causes the generation and storing of data representative of a second Nodal Object 1242 in the same way as the terminal of user 101 in step 203.

In step 212, the Algorithm management Module 127 computes and stores the Distance 1272 between this second Nodal Object 1242 and the first Model 1254 and more generally all the Models of the active Business Universe, according to a process described in detail below, and establishes and stores a list of a maximum of N Models (with N for instance equal to 5), the Distance 1272 of which to this Nodal Object 1242 is the shortest.

In step 213, the Viewer 1221, in cooperation with Modules 124, 125, 127, proposes to the second user 102 to apply stored data representative of this first Model 1254 (or another Model from this list) to this second Nodal Object 1242. To this end, the titles of the Models of this list are presented in a menu 12218 of this Viewer 1221.

Referring to FIG. 5, this list is restricted to the sole Model 1254 having “Risk” as title 12545. Therefore, only the title of Model 1254 having <<Risk>> as title 12545 has been selected in step 2122 that is described below and appears in menu 12218.

In step 214, upon validation by input from user 102 on his terminal, the Nodal Object management Module 124 executes instructions for applying data representative of this first Model 1254 to this second Nodal Object 1242 according to a method described in detail below.

Referring to FIG. 5, the user clicks on the title 12545 of the Model labeled “Risk” in the message box 12218 to cause the application of the structure this Model “Risk” 1254 to this Nodal Object labeled “First Risk” 1242. To facilitate the understanding, this Nodal Object 1242 is marked 1242A and 1242B respectively before and after such application.

### d) Generation or Modification of a Nodal Object

In step 221, an input by user 101,102 causes the generation and storing of an additional Nodal Object 1243, either according to the method described in step 203, or by instantiation of an existing Model.

In this second case, and referring to FIG. 3, he selects a Model other than “Empty Nodal Object” in the list of Models of Business Universe 1231. Referring to FIG. 4, user 101, 102 can also cause the modification of an existing Nodal Object 1241, thanks to the Viewer 1221, by one of the following actions: modification of the title 12415, modification of the wording, of the format or of the value of a Property 12411, deletion or addition of a Property, the latter being done by activation of the Property Generation Button 12215, all the results of the corresponding actions being stored in the server memory.

### e) Modification of a Model

In step 231, a user 101, 102 causes via his terminal the generation and storing of a Model according to step 204, or the modification of data representative of an existing Model 1251 thanks to a Viewer 1221 in cooperation with the Model management Module 125 according to one of the following actions: modification of the title 12515, modification of the wording or the format of a Property 12511, addition or deletion of a Property 12516, and storing of the respective results. When this Model is modified, its version is updated in the Business Universes 1231-1232 to which it is associated, in particular for the generation of new Nodal Objects in step 221.

### f) Application of a Model

In step 241, a user 101-102 causes data representative of a Model 1254 to be applied to a Nodal Object 1241 in the same way as in step 214.

### g) Iterative Loop

Steps 221, 231 and 241 are iterative, i.e. users 101, 102 can cause the reiteration in a collaborative or non-collaborative manner of the steps 221, 231 and 241 to cause the modification of data representative of a Nodal Object or of an existing Model until they converge to a state that is considered as consistent, meaningful and representative for the business for both users 101-102.

### h) Human-Machine Interface for Space Access

The human-machine interface used in particular for accessing a Space in steps 201-202 will now be illustrated.

Referring to FIG. 3, user 101 can interact with the system thanks to Viewer 1221. The name of user 101 <<Summer Garreau>> is displayed in a special window 12211. Thanks to a Mind-Mapping Editor 12214, data representative of a Nodal Object 1241 is represented in the Viewer 1221 by a node of an Object Diagram, as a disk-shaped display associated to a wording corresponding to the title 12415 of this Nodal Object.

By mouse action on the Nodal Object 1242, context menus are displayed as overlaid sectors. The sub-menus are displayed radially.

The data representative of Space 1211 are also displayed in the form of an interactive disk allowing access to radial menus. The Business Universe 1231 is represented by one of these menus and lists a set names of Models 1251-1252. In this list, a first Model 1251 is entitled “Empty Nodal Object”. Clicking on a Model 1251 causes the opening at the terminal of user 101 of a Record Editor 12212 and the generation and storing of data representative of a new Nodal Object 1241, which instantiates this Model 1251.

### i) Human-Machine Interface for Nodal Object Generation

The human-machine interface used in particular for the generation of Nodal Objects in steps 203, 211, 221 will now be described.

Referring to FIG. 4, data of Viewer 1221 contains instructions forming a Record Editor 12212 allowing user 101 named “Summer Garreau” to cause the generation or the edition of data representative of a Nodal Object 1241 characterized by a stored title 12415 and stored Properties 12411, 12412, 12413, 12416 each comprising at least one wording (“type”, “probability”) and optionally a value and a format (text, number, integer, percentage, list). Moreover, the data of Viewer 1221 contain a key for generating and storing a Property 12215, entitled <<Add an attribute>>, a Model application key 12217 allowing to apply data representative of an existing Model to the Nodal Object 1241, in particular in steps 214 et 241, a Model generation key 12216 allowing to generate and store a declaration of the Nodal Object 1241 as a Model, in particular in steps 204 et 231.

As an alternative, user 101 causes the execution by server of instructions forming a free text Editor 12213. In this case, this semi-structure is defined by line feeds, tabulations and dashes. As another alternative, the user 101 causes the execution by server of instructions forming a mind mapping Editor 12214, and this semi-structure is defined by the inputted and stored tree-structure.

### j) Recognition Algorithm

The operation of the instructions forming the Recognition Algorithm 1271 implemented in steps 203, 211, 221, as the generation and storing of the Nodal Objects progresses, will now be explained.

Referring to FIG. 5, instructions forming a Record Editor 12212 allow to inputs by a user 102 to generate and store data representative of a Nodal Object 1242A. The characteristics thereof are:
the title <<First risk>> 12425;
the Property 12421 entitled “type”, having a format “list” and a value “Technical risk”;
the Property 12422 entitled <<important>>, having a format “number” and a value “5”;
the Properties 12424 and 12426 entitled <<statute>> and <<priority>>, of undeclared format and value.

On this basis, the instructions forming the Recognition Algorithm 1271 prepare and store a Nodal Object structure 1242 comprising:
a title,
four level-1 Properties having the respective formats <<enumeration>>, >> number>>, <<undeclared>> and <<undeclared>> of the respective values <<Technical risk>>, <<5>>, <<undeclared>> and <<undeclared>>.

The instructions forming Algorithm 1271 also establishes and stores a Composition link between the Nodal Object and these Properties.

As an alternative, instructions forming a free text Editor 12213 allows user to visualize and modify by user inputs the following tree-structure:

```
First risk
    Type
        Technical risk
    Important
        5
```

The instructions of Recognition 1271 identify the Composition links of Nodal Object 1242 by following the indicators of the stored tree-structure such as <<TAB>> or <<*>>.

As another alternative, instructions forming a Mind-Mapping Editor 12214 allow user actions to cause the declaration of Composition links, and the storing thereof, graphically.

### k) Distance Computation

The sub-steps for computing a Distance will be described below by taking over the references of step 212, but by broadening it to the general case, i.e. when several Models 1251-1252-1253-1254 have already been generated and stored.

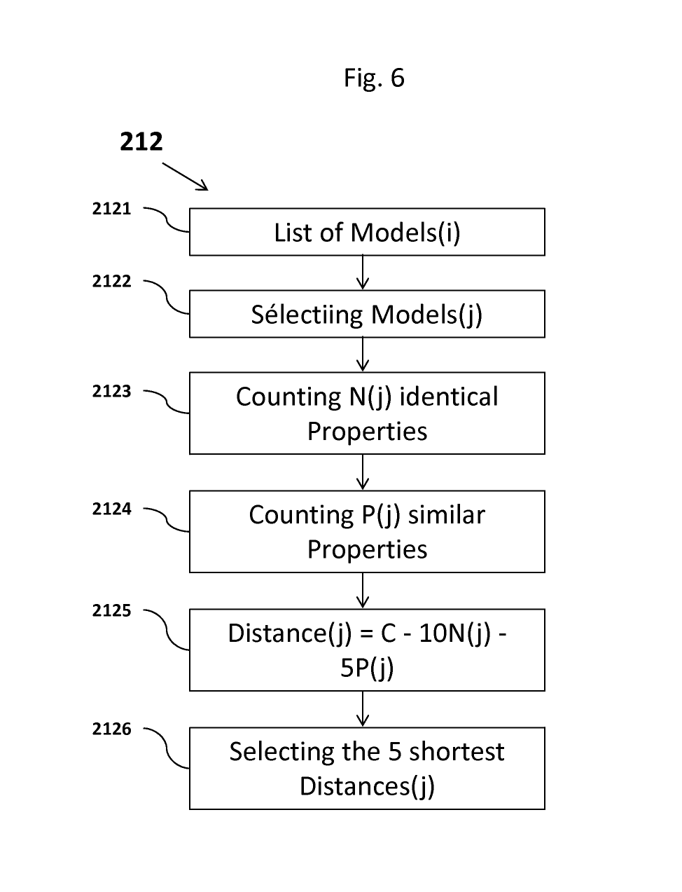

Referring to FIG. 6, in step 2121, the Algorithm management Module 127, in cooperation with Modules 123 and 125, sets up and stores the list of the Models 1251-1252-1253-1254 of the Business Universe 1231 associated to Space 1211.

In step 2122, Module 127 selects from this list the Models(j) 1251-1252-1253-1254 that have at least M Properties (M being for instance equal to 2) in common with the second Nodal Object 1242, i.e. the wordings and formats of which are identical.

In step 2123, for each Model(j) 1251-1252-1253-1254 of this selection, Module 127 establishes and stores the number N(j) of Properties in common with Nodal Object 1242.

In the example of FIG. 5, Model 1254 and Nodal Object 1242A have in common the stored Property 12541, 12421 entitled “type” and the stored Property 12544, 12426 entitled “priority”, i.e. N=2.

In step 2124, for each Model(j) 1251-1252-1253-1254 of this selection, Module 127 executes instructions for determining the number P(j) of Property values which are similar to those in the stored data representative of Nodal Object 1242. This similarity is established if, for two Property values 12541-12421 compared with each other, (i) their format is identical, (ii) their wording shares a given percentage, e.g. 80%, of the characters and (iii) a given percentage of these characters, e.g. 80% again, are present in the same order.

In the example of FIG. 5, the data representative of Model 1254 and the data representative of Nodal Object 1242A contain two Properties 12543 and 12422 of the same “integer” format. The wording “important” of Property 12422 shares 8 of the 10 characters, i.e. 80%, of the wording “importance” of Property 12543. The characters shared between these two wordings, i.e. “importan”, further are in the same order. The three criteria (i), (ii) and (iii) are thus met and P=1.

In step 2125, for each Model(j) 1251-1252-1253-1254 of this selection, Module 127 executes instructions for computing the Distance(j) 1272 according to the formula:

Distance(j)=C−10×N(j)−5×P(j)

where C is a stored constant.

In step 2126, Module 127 executes instructions for selecting at most 5 Models(j), the Distance (j) of which to the Nodal Object 1242 is the shortest the Distance(j) of which is shorter than a constant value D.

In the example of FIG. 5, the data representative of Model 1254 and the data representative of Nodal Object 1242A contain two common Properties and one similar Property. With constants C=100 and D=80, the Distance 1272 is expressed as:

Distance=100−20−5=75

and Model 1254 is selected.

### l) Applying a Model to a Nodal Object

The sub-steps of applying a Model 1254 to a Nodal Object 1242 are detailed below, the reference signs of step 214 being taken over.

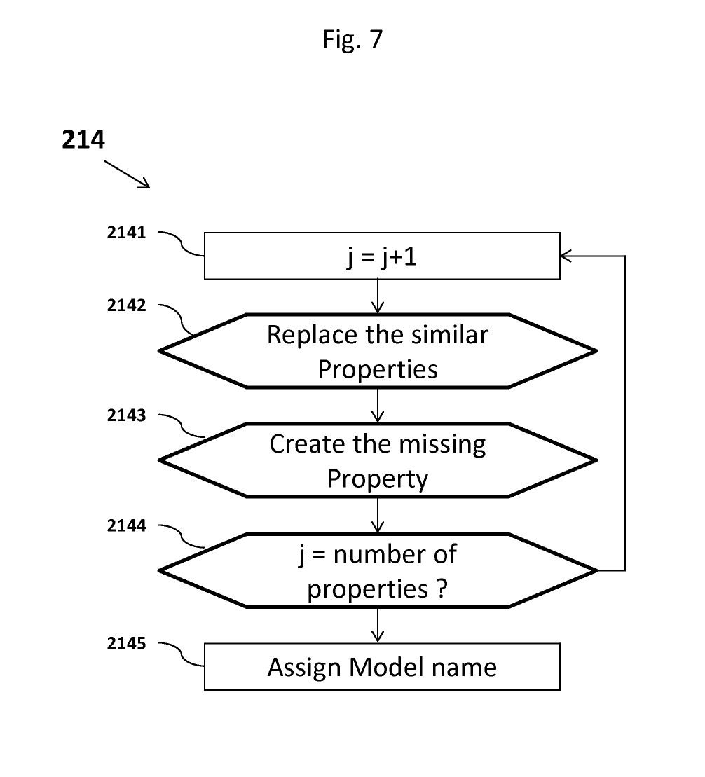

Referring to FIG. 7, in step 2141, the Algorithm management Module 127 causes the incrementation of the stored index j and selects the Property(j) 12541-12542-12543-12544 of Model 1254.

In step 2142, Module 127 executes instructions identifying the Properties 12422 similar to Property(j) 12543. This similarity is determined according to the criteria described above in step 2124. The Nodal Object management Module 124 executes instructions replacing in the memory the wording of similar Properties 12422 with the wording of Property 12543.

In the example of FIG. 5, the Properties 12543 and 12422 are similar. The wording “important” of Property 12422 is replaced in the data representative of Nodal Object 1242B by the wording “importance” stored in the data representative of Property 12543.

In step 2143, Module 127 causes the execution of instructions identifying a missing Property(j) 12542, i.e. the fact that no Property 12421-12422-12424-12426 contained in the data representative of Nodal Object 1242A is identical or similar to this Property(j) 12542 contained in the data representative of Model 1251. The Nodal Object management Module 124 then causes the execution of instructions to add a new Property 12423 to the data representative of Nodal Object 1242B by copying the wording and the format of Property 12542.

In the example of FIG. 5, the Property 12542, the wording of which is “probability” and the format if which is “percentage”, is missing in the stored data representative of Nodal Object 1242A entitled “First Risk”. Module 124 thus executes instructions to add a new Property 12423 to the data representative of Nodal Object 1242B by copying the wording “probability” and the format “percentage” of Property 12542.

In step 2144, Module 127 executes instructions checking that all the Properties(j) have been analyzed and, if not, loops back to step 2141.

In step 2145, Module 124 causes the execution of instructions assigning to the Nodal Object 1242B a Model name 12427 by copying the Model title 12545 and storing this title in the data representative of said Nodal Object. In the example of FIG. 5, this title is “Risk”.

### 4) Variants

The users can cause by user inputs on their terminals the reorganization of data representative of a Space 1211 into data representative of sub-Spaces 12111, 12112, 12113, for example dedicated to projects, depending on their access rights. The Spaces 1211, 1212, 1213 can have intersections containing so-called “shared” Nodal Objects.

A Viewer 1221 can display a Property in the form of sorted, filtered, coloured data, etc.

The display disk of a Nodal Object can be associated to an icon, or comprise displays of stored Property values of such as a degree of progress of a project or a cost, in the form of a bar chart, sectors, circle segments or angular cursor.

Depending on the access rights 1261, 1262, 1263, a Model can be private, public or reserved, for the possible needs of the confidentiality or marketing thereof.

A Template is an assembly of Models. The Distance 1272 can then be computed between a Nodal Object and a Template.

The method 200 can be performed by more than two user terminals accessing the same Space 1211. In step 2043, the user can, depending on his rights 1261, cause the forcing of the association of this Model to another existing Business Universe 1232.

At the end of the method 200, the resulting data representative of Model(s) can be:
in a “use” case, used by two parties to generate and store data representative of new Nodal Objects adopting this Model common to the two parties;
in an “improvement” case, since the business processes may evolve over time and the need for information complementary to the Model may appear over time, the Model is modified/enriched/amended by one or several users.

1. A computer system for collaborative development of common business models, said system comprising:
a set of user terminals,
a server accessible by said user terminals, said server comprising a processor and a server memory, and further comprising:
a module capable of executing instructions for defining and storing in the server memory data representative of a plurality of business universes, each business universe being associated to a corporation activity and including data representative of a plurality of models, each model comprising a data structure corresponding to a type of corporate activity,
a space defining unit for defining and storing data representative of a plurality of spaces, each space being associated to one among a plurality of business universe identifiers and to at least one identifier of an authorized user, and data representative of a plurality of nodal objects, each nodal object being an object of a graph and the data thereof containing data items generated by users inputs,
at least one viewer including a human-machine interface for accessing the spaces by entitled users at respective user terminals, for creating or editing models and storing the resulting data, and for creating and editing nodal objects in the respective spaces and storing the resulting data,
a distance determination unit comprising instructions capable of computing a distance value between data representative of said nodal objects and data representative of said models,
a nodal object/model convergence unit comprising instructions for iteratively for assigning a model to nodal objects generated by different users, and for making data representative of nodal objects mutually consistent, in response to the Distance determination unit,
whereby different nodal objects generated by different users can be caused to converge towards common models.

2. The system according to claim 1, further comprising a recognition unit comprising instructions capable of being executed by said server processor for recognizing nodal object structures edited in a Viewer, and wherein said nodal object/model convergence unit is capable of assigning models to nodal objects also in response to the recognition unit.

3. The system according to claim 2, wherein said recognition unit comprises instructions capable of being executed by said server processor for recognizing data structures based on data links and data formats.

4. The system according to claim 1, wherein said distance determination unit comprises instructions capable of being executed by said server processor for detecting format identities and content similarities.

5. The system according to claim 1, wherein said Viewer comprises means for generating and storing a nodal object from an “empty nodal object” model among said models.

6. The system according to claim 1, further comprising a viewer management unit for managing a plurality of viewers, each viewer being built from one or several editors of different types.

7. The system according to claim 2, wherein said recognition unit comprises instructions capable of being executed by said processor for detecting tree-structures in data inputted by users and for generating corresponding data structures in nodal objects.

8. The system according to claim 1, wherein said Viewer comprises instructions capable of being executed by said processor for generating and storing a new model from the stored data structure of a generated nodal object.

9. The system according to claim 1, wherein said nodal object/model convergence unit comprises instructions capable of being executed by said processor for displaying a plurality of model names sorted out in response to distance determination by said distance determination unit.

10. The system according to claim 1, wherein said nodal object/model convergence unit comprises instructions capable of being executed by said processor for copying data items from models to nodal objects to which such models have been assigned.

11. A computer-implemented method for collaborative development of common business models by a plurality of users, said method comprising the following steps:
providing a set of user terminals and a server accessible by said user terminals, the server comprising a server processor and a server memory, the server processor comprising a business universe module, a space unit, a distance unit and a convergence unit;
defining, by the business universe module, a plurality of business universes, each business universe being associated to a corporation activity and including a plurality of models, each model comprising a data structure corresponding to a type of corporate activity, and storing data representative of said business universes in the server memory;
defining, by the space unit, a plurality of spaces, each space being associated to one among a plurality of business universe identifiers to at least one identifier of an authorized user, and a plurality of nodal objects, and storing data representative of said spaces in the server memory, each nodal object being an object of a graph and comprising data items generated by users inputs;
in response to inputs by a plurality of authorized users through the user terminals in a given space, generating in and editing in dedicated viewer models and nodal objects;
as said models and nodal objects are generated and edited:
performing, by the distance unit, distance determination between inputted data, iteratively for assigning models to nodal objects generated by different users, and making nodal objects contents mutually consistent, in response to the recognition and distance determination steps, whereby different nodal objects generated by different users can be caused to converge by the convergence unit towards common models.

12. The method according to claim 11, further comprising, as said models and nodal objects are generated and edited:
performing data structure recognition on said nodal objects.

13. The method according to claim 12, wherein said recognition step is capable of data structure recognition based on data links and data formats.

14. The method according to claim 11, wherein said distance determination step is capable of detecting format identities and content similarities.

15. The method according to claim 11, wherein said generating and editing step comprises generating a nodal object from an “empty nodal object” model among said models.

16. The method according to claim 11, comprising an initial step of selecting one particular viewer among a plurality of viewers, each viewer being built from one or several editors of different types.

17. The method according to claim 12, wherein said recognition step is capable of detecting tree-structures in data inputted by users and for generating corresponding data structures in nodal objects.

18. The method according to claim 11, wherein said generating and editing step comprises generating a new Model from the data structure of a generated nodal object.

19. The method according to claim 11, wherein said assignment step involves displaying a plurality of model names sorted out in response to the distance determination step.

20. The method according to claim 11, comprising a step of copying data items from models to nodal objects in response to assignments.
